(19) United States
(12) Patent Application Publication
(10) Pub. No.: US 2015/0189333 A1
(43) Pub. Date: Jul. 2, 2015

(54) METHOD AND SYSTEM FOR IMAGE PROCESSING, DECODING METHOD, ENCODER, AND DECODER

(71) Applicant: Industrial Technology Research Institute, Hsinchu (TW)

(72) Inventors: Chun-Lung Lin, Yunlin County (TW); Fan-Di Jou, Hsinchu County (TW)

(21) Appl. No.: 14/583,111

(22) Filed: Dec. 25, 2014

Related U.S. Application Data
(60) Provisional application No. 61/921,091, filed on Dec. 27, 2013.

(30) Foreign Application Priority Data
Dec. 4, 2014 (TW) 103142135

(51) Int. Cl. H04N 19/90

(52) U.S. Cl. CPC H04N 19/90

(57) ABSTRACT

Image processing and decoding methods for intra block copy and a system, encoder and decoder thereof are provided. The image processing method includes dividing a coding unit in an encoding frame into a plurality of sub-blocks, wherein the size of the coding unit is 2N×2N, and the size of the sub-blocks is N×2N or 2N×N, wherein N is a positive integer. The image processing method also includes searching a reference block corresponding to one of the sub-blocks within a searching range in the encoding frame and recording a relative position between the one of the sub-blocks and the reference block corresponding to the one of the sub-blocks. The image processing method further includes encoding the one of the sub-blocks according to the relative position.

### CROSS-REFERENCE TO RELATED APPLICATION

This application claims the priority benefits of U.S. provisional application Ser. No. 61/921,091, filed on Dec. 27, 2013 and Taiwan application serial no. 103142135, filed on Dec. 4, 2014. The entirety of each of the above-mentioned patent applications is hereby incorporated by reference herein and made a part of this specification.

### TECHNICAL FIELD

The present disclosure relates to an image processing method, a decoding method, and an image processing system, an encoder, and a decoder.

### BACKGROUND

With advancements in technologies, demands for higher quality and larger size of video frame continue to increase as resolution, specification and size of a video display all becoming higher. To satisfy the demands, Joint Collaborative Team on Video Coding (JCT-VC) co-founded by Video Coding Experts Group (VCEG) under ITU-T and Moving Picture Experts Group (MPEG) under ISO/IEC has started to work on H.265/HEVC (High Efficiency Video Coding) project which aims to provide an encoding efficiency higher than that of a video compression standard of H.264/AVC (Advanced Video Coding) for saving approximately 50% of bit rate under the same subjective quality. The project is important for high resolution videos such as HD (High Definition), Ultra HD (Ultra High Definition), and the like.

An environment for such video application in large size and high resolution mostly include natural video images and was finalized in 2013. Currently, range extensions of H.265/HEVC are under establishment, which includes establishment of Screen Content Coding (SCC) standard required by screen sharing application services. A video content for screen sharing usually includes a hybrid video content material. For example, a frame may include a natural image, a massive amount of text, a mouse pointer or various lines and the like. Because the target designed by H.265/HEVC is inadequate for this screen application environment, JCT-VC has recently changed its focus onto developments for new screen coding standard technology with higher performance. SCC is developed based on existing tools of H.265/HEVC, and Intra Block Copy (IBC) is a new tool developed from SCC. A technical concept of IBC is to directly copy a frame content of a nearby block to a coding unit (CU) which is being encoded, so as to reduce a bit transmission amount. A background of such design is based on the fact that there are more lines and characters in the screen application environment, such that it is highly possible that the frame of the nearby block is similar to the frame of the coding unit which is being encoding.

In implementation of the H.265/HEVC standard and IBC, one coding tree unit (CTU) is used as a maximum processing block for encoding the coding unit. A size of the coding tree unit is usually set to a 64×64 block, in which a unit of the size of the coding tree unit is pixels. The coding unit may be less than or equal a block size of the coding tree unit. For example, the coding unit is a block of a square having a size of 64×64, 32×32, 16×16, or 8×8.

FIG. 1 is an example illustrating operations using existing intra block copy (IBC) according to conventional art.

Referring to FIG. 1, in a designated searching range, an encoding terminal searches nearby reference blocks having the same size of a coding unit 102 that is being encoded and performs comparison. After comparing each of the reference blocks, a reference block 104 having a frame most similar to the coding unit 102 may then be found. The encoding terminal transmits a relative position between the selected reference block and the coding unit 102 to a decoding terminal. Then, the decoding terminal may copy the frame of the reference block to the coding unit 102. The searching range of IBC technology may be a size of one coding tree unit (e.g., a coding tree unit 100-1) as well as a size of two coding tree units (the coding tree unit 100-1 and a coding tree unit 100-2).

In view of above, it can be known that the concept of the existing intra block copy is to copy the reference block having the same size of the coding unit that is being encoded to the coding unit that is being encoded. However, IBC technology is restricted by searching the corresponding reference block based on the size of the coding unit, such that a chance for finding the matching reference block is relatively low to thereby affect an encoding performance. Accordingly, how to find the suitable reference block more quickly in order to reduce a time required for encoding operations is an issue.

### SUMMARY

The present disclosure is directed to an image processing method, an image processing system, an encoder, and a decoder.

An exemplary embodiment of the present disclosure provides an image processing method, and the image processing method includes the following. First, a coding unit in a first coding tree unit in an encoding frame is divided into a plurality of sub-blocks, wherein the size of the coding unit is 2N×2N, and the size of the sub-blocks is N×2N or 2N×N, wherein N is a positive integer. A reference block corresponding to one of the sub-blocks is searched within a searching range in the encoding frame and a relative position between the one of the sub-blocks and the reference block corresponding to the one of the sub-blocks is recorded. The one of the sub-blocks is encoded according to the relative position.

An exemplary embodiment of the present disclosure provides an encoder for image processing in an encoding frame. The encoder module includes a dividing mode setting module, an image dividing module and an encoding module. The dividing mode setting module is configured to select a dividing mode. The image dividing module is configured to divide a coding unit in a first coding tree unit in the encoding frame into a plurality of sub-blocks according to the dividing mode, wherein the size of the coding unit is 2N×2N, and the size of the sub-blocks is N×2N or 2N×N, wherein N is a positive integer. The encoding module is configured to search a reference block corresponding to one of the sub-blocks within a searching range in the encoding frame. The encoding module is further configured to record a relative position between the one of the sub-blocks and the reference block corresponding to the one of the sub-blocks, and encode the one of the sub-blocks according to the relative position.

An exemplary embodiment of the present disclosure provides a decoder for image processing in a decoding frame. The decoder module includes a dividing mode receiving module and a decoding module. The dividing mode receiving module is configured to receive a dividing mode. The decoding module is configured to receive a relative position between one of sub blocks divided from a coding unit in a first coding tree unit and a reference block corresponding to the one of the sub-blocks, wherein the size of the coding unit is 2N×2N, and the size of the sub-blocks is N×2N or 2N×N, wherein N is a positive integer. The decoding module is further configured to decode the one of the sub-blocks in the decoding frame according to the dividing mode, the relative position and the reference block corresponding to the one of the sub-blocks. The reference block is a sub-block corresponding to the one of the sub-blocks and is within a searching range in the decoding frame.

An exemplary embodiment of the present disclosure provides an image processing system, and the image processing system includes an encoder module and a decoder module. The encoder module has a dividing mode setting module, an image dividing module and an encoding module. The decoder module has a dividing mode receiving module and a decoding module. The dividing mode setting module is configured to select a dividing mode. The image dividing module is configured to divide a coding unit in a first coding tree unit in an encoding frame into a plurality of sub-blocks according to the dividing mode, wherein the size of the coding unit is 2N×2N, and the size of the sub-blocks is N×2N or 2N×N, wherein N is a positive integer. The encoding module is configured to search a reference block corresponding to one of the sub-blocks within a searching range in the encoding frame, and record a relative position between the one of the sub-blocks and the reference block corresponding to the one of the sub-blocks. In addition, the encoding module is further configured to encode the one of the sub-blocks according to the relative position.

An exemplary embodiment of the present disclosure provides a decoding method, and the decoding method includes the following. A relative position between one of sub blocks divided from a coding unit in a first coding tree unit and a reference block corresponding to the one of the sub-blocks is received, wherein the size of the coding unit is 2N×2N, and the size of the sub-blocks is N×2N or 2N×N, wherein N is a positive integer. The one of the sub-blocks is decoded in a decoding frame according to the relative position and the reference block corresponding to the one of the sub-blocks. The reference block is a sub-block corresponding to the one of the sub-blocks and is within a searching range in the decoding frame.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is an example illustrating operations using existing intra block copy (IBC) according to conventional art.

FIG. 2 is a flowchart illustrating an image processing method according to the present disclosure.

FIG. 3A illustrates an encoder according to a first exemplary embodiment of the present disclosure.

FIG. 3B illustrates a decoder according to the first exemplary embodiment of the present disclosure.

FIG. 3C illustrates an image processing chip according to the first exemplary embodiment of the present disclosure.

FIG. 4 is a schematic diagram illustrating an image processing operation according to the first exemplary embodiment of the present disclosure.

FIG. 5 is a schematic diagram illustrating an image processing operation according to a second exemplary embodiment of the present disclosure.

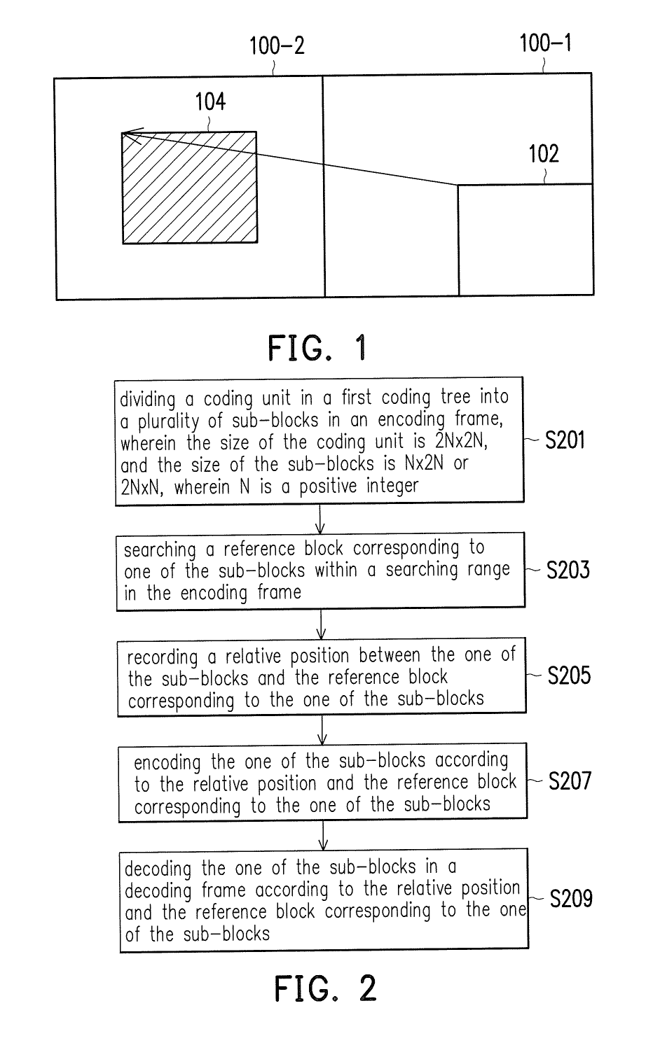

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

FIG. 2 is a flowchart illustrating an image processing method according to the present disclosure. Referring to FIG. 2, in order to effectively improve the encoding performance of the screen video coding technology, an image processing method is provided according to an embodiment of the present disclosure. The method includes dividing a coding unit in a first coding tree unit in an encoding frame into a plurality of sub-blocks, wherein the size of the coding unit is 2N×2N, and the size of the sub-blocks is N×2N or 2N×N, wherein N is a positive integer (S201). Then, within a searching range, searching a reference block corresponding to one of the sub-blocks (S203). Next, recording a relative position between the one of the sub-blocks and the reference block corresponding to the one of the sub-blocks (e.g., a block motion vector between the one of the sub-blocks and the reference block corresponding to the one of the sub-blocks) (S205), and encoding the one of the sub-blocks according to the relative position and the reference block corresponding to the one of the sub-blocks (S207). The method further includes decoding the one of the sub-blocks in a decoding frame according to the relative position and the reference block corresponding to the one of the sub-blocks (S209). Accordingly, by dividing the coding unit into two sub-blocks having the size of N×2N or 2N×N, the reference blocks appropriate and matching the corresponding sub-blocks may be found quickly when performing the intra block copy in image encoding process, so that the time required for encoding operations may be reduced. As a result, the encoding performance of the screen video encoding technology may be effectively improved. Several exemplary embodiments are described below for better understanding of the present disclosure.

### First Exemplary Embodiment

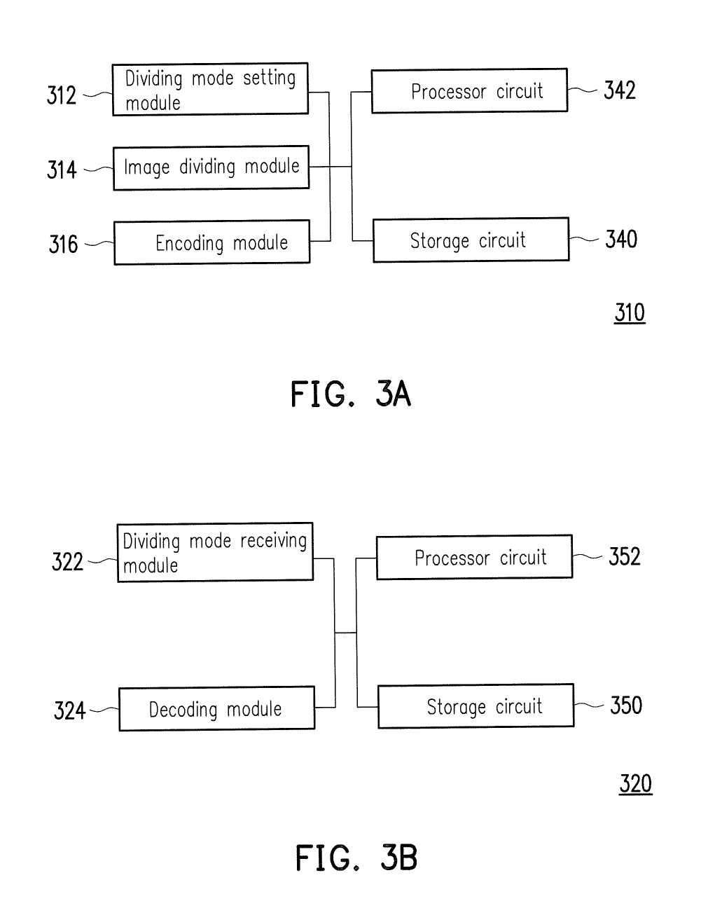

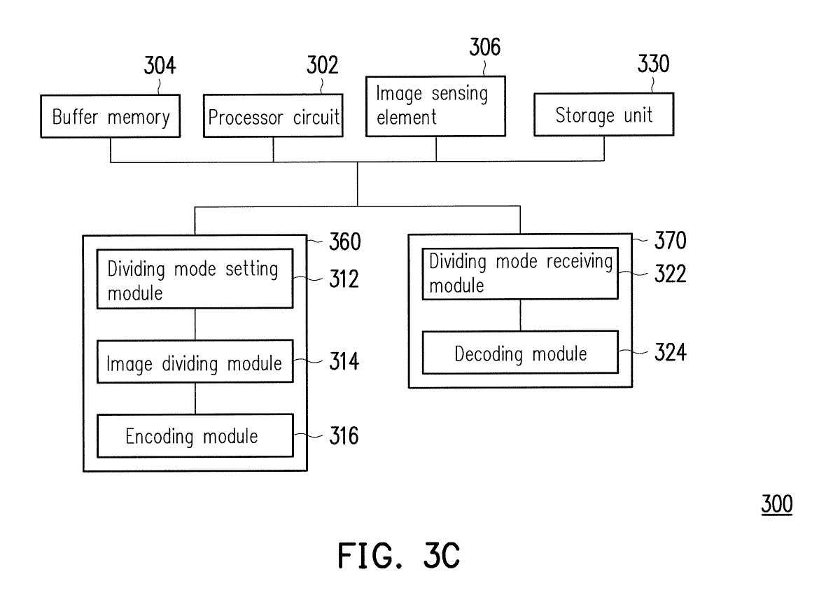

FIG. 3A illustrates an encoder according to a first exemplary embodiment of the present disclosure.

Referring to FIG. 3A, an encoder 310 includes a dividing mode setting module 312, an image dividing module 314, an encoding module 316, a storage circuit 340, and a processor circuit 342.

In the present exemplary embodiment, the storage circuit 340 is configured to store various data, programming codes, or images pending for processing and images being processed. For example, the storage circuit 340 may be a storage medium such as a memory or a hard disk drive (HDD), but the present disclosure is not limited thereto. The processor circuit 342 may be a central processing unit (CPU), a micro-processor or an embedded controller, which are not particularly limited in the present disclosure. The processor circuit 342 is coupled to the storage circuit 340, and configured to execute the dividing mode setting module 312, the image dividing module 314 and the encoding module 316.

The dividing mode setting module 312 is configured to select a dividing mode. The image dividing module 314 is configured to divide a coding unit in a coding tree unit in an encoding frame into a plurality of sub-blocks according to the dividing mode selected by the dividing mode setting module 312. For example, the dividing mode setting module 312 selects the proper dividing mode according to a performance required for performing each dividing mode and a capability of the encoder 310. However, in another exemplary embodiment, the dividing mode setting module 312 may also select the dividing mode according to any conditions or algorithms, which are not particularly limited in the present disclosure. For example, in an exemplary embodiment, the dividing mode setting module 312 may randomly or sequentially select one among multiple dividing modes. In addition, the dividing mode setting module 312 may also set the dividing mode through a selection inputted by users.

For example, under the H.265/HEVC standard, one coding tree unit (CTU) is used as a maximum encoding block for encoding the coding unit. The size of the coding tree unit is usually set to a 64×64 block. A block size of the coding unit may be less than or equal to a block size of the coding tree unit. For instance, the coding unit is a block of a square having the size of 64×64, 32×32, 16×16, or 8×8. In the exemplary embodiments of the present disclosure, units of sizes of blocks (e.g., the coding tree unit, the coding unit, the sub-blocks, the reference block, etc.) and ranges are pixels. The image dividing module 314 divides the coding unit into two sub-blocks having the size of N×2N or 2N×N according to the dividing mode received from the dividing mode setting module 312.

The encoding module 316 searches reference blocks corresponding to the divided sub-blocks within the searching range in the encoding frame and records relative positions between the sub-blocks and the reference blocks corresponding to the sub-blocks, so as to encode the sub-blocks divided by the image dividing module 314 respectively according to the reference blocks corresponding to the sub-blocks and the relative positions thereof. In an exemplary embodiment of the present disclosure, the relative position between the sub-block and the reference block is, for example, a block motion vector, such that a decoding terminal may locate the relative position of the reference block according to the block motion vector and copy a content of the reference block into a decoding block. In another embodiment, the encoding module 316 may compress the block motion vector corresponding to the relative position so that the encoding module 316 may utilize the previous block motion vector to predicate the current block motion vector during the encoding process. In yet another embodiment, the encoding sub-block may not be completely identical to the reference block, and a slight error is allowed. For example, an error value between the encoding sub-block and the reference block is also known as a residual value, and the encoding module 316 also compresses the residual values.

After aforesaid encoding process is completed, the encoder 310 may transmit encoded data to a decoder for decoding. For example, the encoded data is a series of encoding bit information which may include information such as the relative position for locating the reference block, the residual value and the dividing mode as described above. As such, the decoder may restore pixel data according to aforesaid information. For example, in an exemplary embodiment of the present disclosure, the encoder 310 is implemented in an image sending terminal, and the decoder is implemented in an image receiving terminal, wherein the encoder and the decoder are communicated in a wired or a wireless manner.

FIG. 3B illustrates a decoder according to the first exemplary embodiment of the present disclosure.

Referring to FIG. 3B, a decoder 320 includes a dividing mode receiving module 322, a decoding module 324, a processor circuit 352, and a storage circuit 350. The storage circuit 350 is configured to store various data, programming codes, or images pending for processing and images being processed. Further, the processor circuit 352 is coupled to the storage circuit 350 to execute the dividing mode receiving module 322 and the decoding module 324.

With respect to the encoder 310, the decoder 320 receives aforesaid encoding bit information, and analyzes the meaning of each bit information from the series of the encoding bit information. For example, the decoder 320 analyzes and obtains the relative position for locating the reference block, the residual value and the dividing mode. Accordingly, the dividing mode receiving module 322 of the decoder 320 receives the dividing mode corresponding to the encoded image from the dividing mode setting module 312 of the encoder 310. The decoding module 324 of the decoder 320 obtains the dividing mode of the sub-blocks in the coding unit according to the dividing mode received by the dividing mode receiving module 322, receives and obtains the relative positions between the sub-blocks divided by the image dividing module 314 and the reference blocks corresponding to the sub-blocks from the encoding module 316 of the encoder 310, and decodes the sub-blocks in a decoding frame respectively according to the received dividing mode, the relative positions and the reference blocks corresponding to the sub-blocks. In the operation of decoding the sub-blocks by the decoding module 324, the decoding module 324 obtains a content corresponding to the reference block from the decoding frame according to the obtained relative position, and copies the content corresponding to the reference block to a position corresponding to the sub-block in the decoding frame.

It is worth mentioning that, the encoder and the decoder are implemented in different terminals and the data are transmitted via a network, but the present disclosure is not limited thereto. In another exemplary embodiment, the encoder and the decoder may be implemented in the same chip or system.

FIG. 3C illustrates an image processing chip according to the first exemplary embodiment of the present disclosure.

Referring to FIG. 3C, an image processing chip 300 (or an image processing system) includes a processor circuit 302, a buffer memory 304, an image sensing element 306, a storage circuit 330, an encoder module 360 and a decoder module 370. The storage circuit 330 is configured to store various data, programming codes, or images pending for processing and images being processed.

The processor circuit 302 is configured to control overall operations of the image processing chip 300. For example, the processor circuit 302 issues a command to the encoder module 360 and the decoder module 370 in order to perform operations of encoding and decoding for video images.

The buffer memory 304 is coupled to the processor circuit 302 and configured to temporarily store data. In the present exemplary embodiment, the buffer memory 304 is a static random-access memory (SRAM). Nevertheless, it should be understood that the present disclosure is not limited thereto. In another exemplary embodiment, the buffer memory 304 may be a dynamic random access memory (DRAM) or other memories.

The image sensing element 306 is coupled to the processor circuit 302. The image sensing element 306 is configured to sense images according to a control of the processor circuit 302 and output corresponding image data. For example, the processor circuit 302 temporarily stores the image data outputted by the image sensing element 306 into the buffer memory 304. It is worth mentioning that, a source of the image is not particularly limited in the present disclosure. For example, in another exemplary embodiment, the image processing chip 300 may not include the image sensing element 306, and the images may come from any external image capturing device and these external images may be received by the processor circuit 302 through transmission. Further, in another exemplary embodiment, the image data may be stored in the storage circuit 330 in advance.

The storage circuit 330 is coupled to the processor circuit 302, the buffer memory 304 and the image sensing element 306. Operations of the encoder module 360 and the decoder module 370 are similar to the encoder 310 and the decoder 320 respectively shown in FIG. 3A and FIG. 3B. For example, the encoder module 360 includes a dividing mode setting module 312, an image dividing module 314 and an encoding module 316. The decoder module 370 includes a dividing mode receiving module 322 and a decoding module 324.

It should be noted that, the encoder and the decoder according to the present disclosure may be implemented by software modules or program codes. For example, the storage circuit 330 stores software program codes of the dividing mode setting module, the image dividing module, the encoding module, the dividing mode receiving module and the decoding module. Later, when the image processing chip 300 is enabled, the software program codes are loaded to the buffer memory 304 from the storage circuit 330 and executed by the processor circuit 302 in order to run functions of the dividing mode setting module, the image dividing module, the encoding module, the dividing mode receiving module and the decoding module. However, the present disclosure is not limited thereto. For example, in another exemplary embodiment of the present disclosure, the image processing chip, the encoder and the decoder may be implemented by hardware circuits. For example, the dividing mode setting module, the image dividing module, the encoding module, the dividing mode receiving module and the decoding module may be implemented by the hardware circuits to become a dividing mode setting circuit, an image dividing circuit, an encoding circuit, a dividing mode receiving circuit and a decoding circuit.

In order to describe the operations of the encoder 310, the decoder 320 and the image processing chip 300 more clearly, an example is further provided below with reference to the image processing chip 300 of FIG. 3C for description.

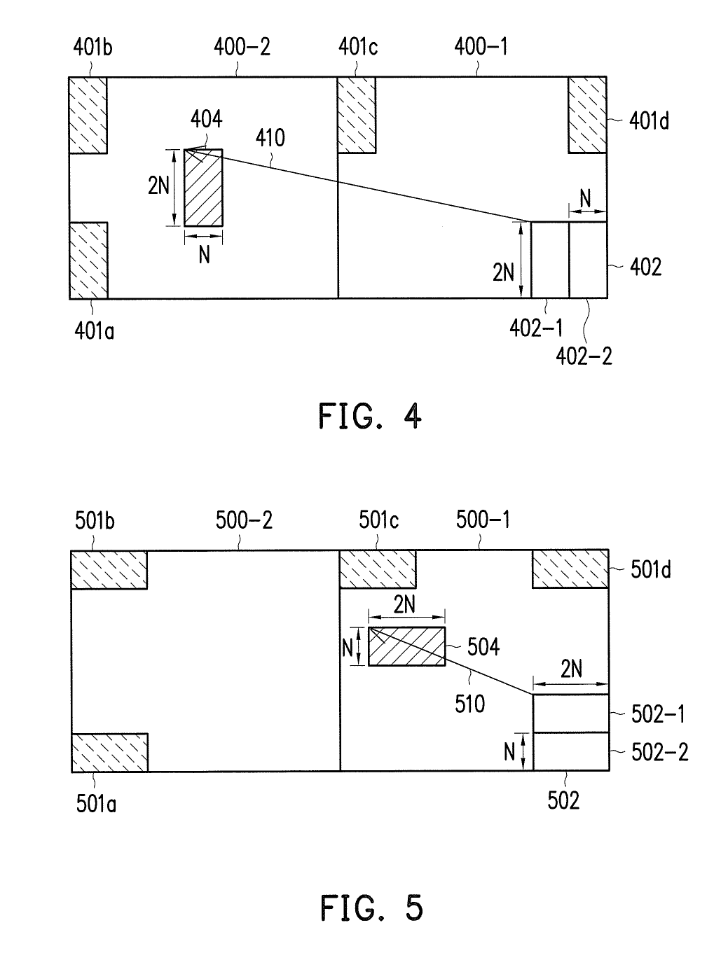

FIG. 4 is a schematic diagram illustrating an image processing operation according to the first exemplary embodiment of the present disclosure.

Referring to FIG. 4, it is assumed herein that a size of a coding unit 402 is 2N×2N, wherein N is a positive integer. Further, the image dividing module 314 divides the coding unit 402 into two sub-blocks 402-1 and 402-2 having the size of N×2N according to a dividing mode selected by the dividing mode setting module 312. For instance, the encoding module 316 searches a plurality of searching blocks having the same size of the sub-blocks 402-1 and 402-2 within a predetermined searching range (i.e., in the present exemplary embodiment, the searching range is two coding tree units, such as a coding tree unit 400-1 and a coding tree unit 400-2) for comparison, so as to find the reference blocks for each of the sub-blocks 402-1 and 402-2. In the present exemplary embodiment, the searching range includes two coding tree units (i.e., the coding tree unit 400-1 and the coding tree unit 400-2). In other words, the searching range extends from the coding tree unit 400-1, where the coding unit 402 to be encoded belongs to, to a block with a width of 64 pixels located on the left side of the coding tree unit 400-1 (take a size of the coding tree unit being 64×64 pixels as an example), but not including the coding unit that is currently to be encoded or blocks in the coding tree unit not yet be encoded. Nonetheless, the present disclosure is not intended to limit an area of the searching range. For example, in another exemplary embodiment, the searching range may also include the coding unit that is currently being encoded or blocks in the coding tree unit not yet be encoded.

For example, in the present exemplary embodiment, in the operation of searching the reference block corresponding to the one of the sub-blocks (e.g., a sub-block 402-1) within the searching range by the encoding module 316, the encoding module 316 searches a plurality of searching blocks within the searching range and calculate pixel values of each of the searching blocks, and calculates a brightness distortion value of each of the searching blocks with respect to the sub-block 402-1 and a number of brightness bits required for encoding each of the searching blocks and the sub-block 402-1 according to the pixel values of each of the searching blocks. Herein, the number of brightness bits required for encoding a searching block and the sub-block 402-1 may be a number of bits required for the block motion vector between the searching block and the sub-block and/or a number of bits required for encoding the residual value.

Thereafter, the encoding module 316 selects a plurality of candidate blocks according to the brightness distortion value corresponding to each of the searching blocks and the number of brightness bits required for encoding each of the searching blocks and the sub-block 402-1. For example, the encoding module 316 calculates a brightness cost value corresponding to each of the searching blocks according to the brightness distortion value corresponding to each of the searching blocks and the number of brightness bits required for encoding the searching blocks and the sub-block 402-1, and uses the searching blocks corresponding to a plurality of minimum values among the brightness cost values as the candidate blocks. The candidate blocks include, for example, eight candidate blocks. In another embodiment, it is also possible that the candidate blocks include six, seven, nine or sixteen candidate blocks, but the present disclosure is not limited thereto.

Thereafter, the encoding module 316 calculates a chroma distortion value of each of the candidate blocks with respect to the sub-block 402-1 and a number of chroma bits required for encoding each of the candidate blocks and the sub-block 402-1 according to the pixel values of each of the candidate blocks, and calculates a total distortion value of the brightness distortion value and the chroma distortion value corresponding to each of the candidate blocks and calculates a total number of bits of the number of brightness bits and the number of chroma bits corresponding to each of the candidate blocks. Next, the encoding module 316 calculates a total cost value corresponding to each of the candidate blocks according to the total number of bits and the total distortion value corresponding to each of the candidate blocks, and the encoding module 316 uses the candidate block corresponding to a minimum value among the total cost values of the candidate blocks as a reference block 404. The brightness distortion value may be represented by sum of absolute difference (SAD), mean squared error (MSE) and the like.

In the present exemplary embodiment, the candidate blocks are first selected by using the brightness distortion value and the required number of brightness bits, and then the reference block 404 are selected by using the brightness distortion value, the chroma distortion value and the required number of bits, but the present disclosure is not limited thereto. In yet another exemplary embodiment, the encoding module 316 may select the most preferable reference block by using the brightness distortion value and the required number of bits. In another embodiment, the encoding module 316 may select the most preferable reference block by using the brightness distortion value, the chroma distortion value and the required number of bits without selecting the candidate blocks in advance.

It is worth mentioning that, a calculating method for obtaining the reference block is not particularly limited in the present disclosure. For example, in another exemplary embodiment, the brightness distortion value, the chroma distortion value and the number of bits required for encoding are calculated according to the coding unit 402 (i.e., the sub-block 402-1 and the sub-block 402-2 being merged) and the searching blocks. For instance, the encoding module 316 calculates the brightness distortion values of the searching blocks with respect to the coding unit 402 and the numbers of bits required for encoding the searching blocks and the coding unit 402. In other words, the brightness distortion values and the numbers of bits required for encoding are not limited only to be calculated by using the sub-block 402-1 and the searching blocks, nor limited only to be calculated by using the sub-block 402-2 and the searching blocks.

After the reference block 404 is obtained by the encoding module 316, the encoding module 316 records the relative position between the sub-block 402-1 and the reference block 404 corresponding to the sub-block 402-1, so as to encode the sub-block 402-1 according to the reference block 404 corresponding to the sub-block 402-1 and the relative position between the sub-block 402-1 and the reference block 404. For example, the encoding module 316 calculates a vector 410 according to a position of the sub-block 402-1 and a position of the reference block 404, and identifies the relative position of the sub-block 402-1 and the reference block 404 by using the vector 410. In the present exemplary embodiment, the encoding module 316 transmits the relative position to the decoding module 324 of the decoder 320 in the decoding terminal. That is, the decoding module 324 in the decoding terminal receives the relative position between the sub-block 402-1 and the reference block 404 corresponding to the sub-block 402-1 from the encoding module 316. Particularly, after the setting is completed according to the selected dividing mode in the dividing mode setting module 312, the encoder 310 also transmits the selected dividing mode to the dividing mode receiving module 322 of the decoder 320 in the decoding terminal. Therefore, in the operation of decoding the sub-block 402-1 by the decoding module 324 in the decoding terminal, the decoding module 324 in the decoding terminal obtains the content corresponding to the reference block 404 from the decoding frame (e.g., the coding tree unit 400-2) according to the dividing mode received by the dividing mode receiving module 322 in the decoding terminal and according to the obtained relative position, and copies the content corresponding to the reference block 404 to a position corresponding to the sub-block 402-1 in the decoding frame according to the relative position.

In the exemplary embodiment of the present disclosure, the searching range of the encoding module 316 includes at least one other sub-block, and before the one of the sub-blocks (e.g., the sub-block 402-1) in the decoding frame is decoded by the decoding module 324, the at least one other sub-block (e.g., the reference block 404) is already decoded. That is, the searching range does not include the coding unit that is currently being encoded or blocks in the coding tree unit not yet be decoded. Nonetheless, the present disclosure is not intended to limit the searching range. For example, in another exemplary embodiment, the searching range may also include the coding unit that is currently being encoded or blocks in the coding tree unit not yet be decoded. In addition, the searching range may include the first coding tree unit 400-1 and at least one second coding tree unit 400-2 adjacent to the first coding tree unit 400-1. In other words, the searching range may be a size of one coding tree unit (e.g., the coding tree unit 400-1) as well as a size of two coding tree units (the coding tree unit 400-1 and the coding tree unit 400-2, wherein the coding tree unit 400-2 is a coding tree unit adjacent to the coding tree unit 400-1), and may even be a size including the coding tree unit 400-1 and a plurality of coding tree units adjacent to the coding tree unit 400-1. However, the present disclosure is not limited thereto. The searching range of the present disclosure may also be a size of the entire frame.

In the present exemplary embodiment, the reference block corresponding to the sub-block 402-1 is the reference block 404, and a vector corresponding to the relative position between the sub-block 402-1 and the reference block 404 is the vector 410. In the present exemplary embodiment, in the operation of comparing and searching the reference blocks corresponding to the sub-blocks 402-1 and 402-2 by the encoding module 316, a farthest frame that the encoding module 316 can search is a block 401a in terms of searching in horizontal direction, a farthest frame that the encoding module 316 can search is a block 401d in terms of searching in vertical direction, and a farthest frame that the encoding module 316 can search is a block 401b in terms of two-dimensional searching.

### Second Exemplary Embodiment

A major difference between the second exemplary embodiment and the first exemplary embodiment is that, a coding unit having the size of 2N×2N is divided into two sub-blocks having the size of 2N×N for image processing in the second exemplary embodiment. The difference between the second exemplary embodiment and the first exemplary embodiment is described below by reference with the system and the reference numbers of the first exemplary embodiment.

FIG. 5 is a schematic diagram illustrating an image processing operation according to a second exemplary embodiment of the present disclosure.

In the present exemplary embodiment, when the dividing mode selected by the dividing mode setting module 312 is to divide the coding unit into two sub-blocks having the size of 2N×N, the image dividing module 314 divides the coding unit into the two sub-blocks having the size of 2N×N according to the dividing mode received from the dividing mode setting module 312. Referring to FIG. 5, the image dividing module 314 divides a coding unit 502 into two sub-blocks 502-1 and 502-2, and a size of each of the sub-blocks is 2N×N. In this exemplary embodiment, the encoding module 316 obtains the appropriate reference blocks corresponding to the sub-blocks 502-1 and 502-2 and relative positions between the sub-blocks and the reference blocks by using an operating method similar to that illustrated in the first exemplary embodiment (which are not repeated hereinafter), so as to copy the reference blocks to positions of the corresponding sub-blocks 502-1 and 502-2. For example, in the present exemplary embodiment, the appropriate reference block corresponding to the sub-block 502-1 being obtained is a reference block 504, and a vector corresponding to the relative position between the sub-block 502-1 and the reference block 504 is a vector 510. Further, in the operation of comparing and searching the reference blocks corresponding to the sub-blocks 502-1 and 502-2 by the encoding module 316, a farthest frame that the encoding module 316 can search is a block 501a in terms of searching in horizontal direction, a farthest frame that the encoding module 316 can search is a block 501d in terms of searching in vertical direction, and a farthest frame that the encoding module 316 can search is a block 501b in terms of two-dimensional searching.

In summary, the image processing method and the image processing system, the encoder and the decoder using the method as proposed by the exemplary embodiments of the present disclosure are capable of dividing the coding unit that is currently encoding into the two sub-blocks having the size of N×2N or 2N×N. As a result, the reference blocks most appropriate and matching the corresponding sub-blocks may be found quickly, so as to reduce the time required for encoding operations and effectively improve the encoding performance of the screen video encoding technology.

It will be apparent to those skilled in the art that various modifications and variations can be made to the disclosed embodiments. It is intended that the specification and examples be considered as exemplary only, with a true scope of the disclosure being indicated by the following claims and their equivalents

What is claimed is:

1. An image processing method, comprising:
dividing a coding unit in a first coding tree unit in an encoding frame into a plurality of sub-blocks, wherein a size of the coding unit is 2N×2N, and a size of the sub-blocks is N×2N or 2N×N, wherein N is a positive integer;
searching a reference block corresponding to one of the sub-blocks within a searching range in the encoding frame;
recording a relative position between the one of the sub-blocks and the reference block corresponding to the one of the sub-blocks; and
encoding the one of the sub-blocks according to the relative position.

2. The image processing method of claim 1, further comprising: decoding the one of the sub-blocks in a decoding frame according to the relative position and the reference block corresponding to the one of the sub-blocks.

3. The image processing method of claim 2, wherein the step of decoding the one of the sub-blocks according to the relative position and the reference block corresponding to the one of the sub-blocks comprises:
obtaining the relative position;
obtaining a content corresponding to the reference block from the decoding frame according to the relative position; and
copying the content corresponding to the reference block to a position corresponding to the one of the sub-blocks in the decoding frame.

4. The image processing method of claim 1, wherein the step of searching the reference block corresponding to the one of the sub-blocks within the searching range comprises:
searching a plurality of searching blocks within the searching range and calculating pixel values of each of the searching blocks;
calculating a brightness distortion value of each of the searching blocks with respect to the one of the sub-blocks and a number of brightness bits required for encoding each of the searching blocks and the one of the sub-blocks according to the pixel values of the searching blocks;
selecting a plurality of candidate blocks according to the brightness distortion value corresponding to each of the searching blocks and the number of brightness bits required for encoding each of the searching blocks and the one of the sub-blocks;
calculating a chroma distortion value of each of the candidate blocks with respect to the one of the sub-blocks and a number of chroma bits required for encoding each of the candidate blocks and the one of the sub-blocks according to the pixel values of the candidate blocks, and calculating a total distortion value of the brightness distortion value and the chroma distortion value corresponding to each of the candidate blocks and calculating a total number of bits of the number of brightness bits and the number of chroma bits corresponding to each of the candidate blocks; and
calculating a total cost value corresponding to each of the candidate blocks according to the total number of bits corresponding to each of the candidate blocks and the total distortion value corresponding to each of the candidate blocks, and using the candidate block corresponding to a minimum value among the total cost values of the candidate blocks as the reference block.

5. The image processing method of claim 3, wherein the searching range comprises at least one other sub-block, wherein before decoding the one of the sub-blocks in the decoding frame, the at least one other sub-block is already decoded.

6. The image processing method of claim 1, wherein the searching range comprises the first coding tree unit and at least one second coding tree unit adjacent to the first coding tree unit.

7. An encoder for image processing in an encoding frame, the encoder comprising:
a dividing mode setting module, wherein the dividing mode setting module selects a dividing mode;
an image dividing module, wherein the image dividing module divides a coding unit in a first coding tree unit in the encoding frame into a plurality of sub-blocks according to the dividing mode, wherein a size of the coding unit is 2N×2N, and a size of the sub-blocks is N×2N or 2N×N, wherein N is a positive integer; and
an encoding module, wherein the encoding module searches a reference block corresponding to one of the sub-blocks within a searching range in the encoding frame,
wherein the encoding module records a relative position between the one of the sub-blocks and the reference block corresponding to the one of the sub-blocks,
wherein the encoding module encodes the one of the sub-blocks according to the relative position.

8. The encoder of claim 7, wherein in the operation of searching the reference block corresponding to the one of the sub-blocks within the searching range by the encoding module, the encoding module searches a plurality of searching blocks within the searching range and calculate pixel values of each of the searching blocks,
wherein the encoding module calculates a brightness distortion value of each of the searching blocks with respect to the one of the sub-blocks and a number of brightness bits required for encoding each of the searching blocks and the one of the sub-blocks according to the pixel values of the searching blocks,
wherein the encoding module selects a plurality of candidate blocks according to the brightness distortion value corresponding to each of the searching blocks and the number of brightness bits required for encoding each of the searching blocks and the one of the sub-blocks,
wherein the encoding module calculates a chroma distortion values of each of the candidate blocks with respect to the one of the sub-blocks and a number of chroma bits required for encoding each of the candidate blocks and the one of the sub-blocks according to the pixel values of the candidate blocks, and calculates a total distortion value of the brightness distortion value and the chroma distortion value corresponding to each of the candidate blocks and calculates a total number of bits of the number of brightness bits and the number of chroma bits corresponding to each of the candidate blocks,
wherein the encoding module calculates a total cost value corresponding to each of the candidate blocks according to the total number of bits corresponding to each of the candidate blocks and the total distortion value corresponding to each of the candidate blocks, and use the candidate block corresponding to a minimum value among the total cost values of the candidate blocks as the reference block.

9. The encoder of claim 7, wherein the searching range comprises the first coding tree unit and at least one second coding tree unit adjacent to the first coding tree unit.

10. An decoder for image processing in a decoding frame, the decoder comprising:
a dividing mode receiving module, wherein the dividing mode receiving module receives a dividing mode; and
a decoding module, wherein the decoding module receives a relative position between one of sub-blocks divided from a coding unit in a first coding tree unit and a reference block corresponding to the one of the sub-blocks, wherein a size of the coding unit is 2N×2N, and a size of the sub-blocks is N×2N or 2N×N, wherein N is a positive integer,
wherein the decoding module decodes the one of the sub-blocks in the decoding frame according to the dividing mode, the relative position and the reference block corresponding to the one of the sub-blocks,
wherein the reference block is a sub-block corresponding to the one of the sub-blocks and is within a searching range in the decoding frame.

11. The decoder of claim 10, wherein in the operation of decoding the one of the sub-blocks according to the relative position and the reference block corresponding to the one of the sub-blocks by the decoding module, the decoding module obtains a content corresponding to the reference block from the decoding frame according to the relative position,
wherein the decoding module copies the content corresponding to the reference block to a position corresponding to the one of the sub-blocks in the decoding frame.

12. The decoder of claim 11, wherein the searching range comprises at least one other sub-block, wherein before decoding the one of the sub-blocks in the decoding frame, the at least one other sub-block is already decoded.

13. An image processing system, comprising:
an encoder module having a dividing mode setting module, an image dividing module and an encoding module; and
a decoder module having a dividing mode receiving module and a decoding module,
wherein the dividing mode setting module selects a dividing mode,
wherein the image dividing module divides a coding unit in a first coding tree unit in an encoding frame into a plurality of sub-blocks according to the dividing mode, wherein a size of the coding unit is 2N×2N, and a size of the sub-blocks is N×2N or 2N×N, wherein N is a positive integer,
wherein the encoding module searches a reference block corresponding to one of the sub-blocks within a searching range in the encoding frame,
wherein the encoding module records a relative position between the one of the sub-blocks and the reference block corresponding to the one of the sub-blocks,
wherein the encoding module encodes the one of the sub-blocks according to the relative position.

14. The image processing system of claim 13, wherein the dividing mode receiving module receives the dividing mode,
wherein the decoding module decodes the one of the sub-blocks in a decoding frame according to the dividing mode, the relative position and the reference block corresponding to the one of the sub-blocks.

15. The image processing system of claim 14, wherein in the operation of decoding the one of the sub-blocks in the decoding frame according to the relative position and the reference block corresponding to the one of the sub-blocks by the decoding module, the decoding module obtains the relative position,
wherein the decoding module obtains a content corresponding to the reference block from the decoding frame according to the relative position,
wherein the decoding module copies the content corresponding to the reference block to a position corresponding to the one of the sub-blocks in the decoding frame.

16. The image processing system of claim 13, wherein in the operation of searching the reference block corresponding to the one of the sub-blocks within the searching range by the encoding module, the encoding module searches a plurality of searching blocks within the searching range and calculate pixel values of each of the searching blocks,
wherein the encoding module calculates a brightness distortion value of each of the searching blocks with respect to the one of the sub-blocks and a number of brightness bits required for encoding each of the searching blocks and the one of the sub-blocks according to the pixel values of the searching blocks,
wherein the encoding module selects a plurality of candidate blocks according to the brightness distortion value corresponding to each of the searching blocks and the number of brightness bits required for encoding each of the searching blocks and the one of the sub-blocks,
wherein the encoding module calculates a chroma distortion value of each of the candidate blocks with respect to the one of the sub-blocks and a number of chroma bits required for encoding each of the candidate blocks and the one of the sub-blocks according to the pixel values of the candidate blocks, and calculates a total distortion value of the brightness distortion value and the chroma distortion value corresponding to each of the candidate blocks and calculates a total number of bits of the number of brightness bits and the number of chroma bits corresponding to each of the candidate blocks,
wherein the encoding module calculates a total cost value corresponding to each of the candidate blocks according to the total number of bits required corresponding to each of the candidate blocks and the total distortion value corresponding to each of the candidate blocks, and uses the candidate block corresponding to a minimum value among the total cost values of the candidate blocks as the reference block.

17. The image processing system of claim 15, wherein the searching range comprises at least one other sub-block, wherein before decoding the one of the sub-blocks in the decoding frame, the at least one other sub-block is already decoded.

18. The image processing system of claim 13, wherein the searching range comprises the first coding tree unit and at least one second coding tree unit adjacent to the first coding tree unit.

19. A decoding method, comprising:
receiving a relative position between one of sub-blocks divided from a coding unit in a first coding tree unit and a reference block corresponding to the one of the sub-blocks, wherein a size of the coding unit is 2N×2N, and a size of the sub-blocks is N×2N or 2N×N, wherein N is a positive integer; and
decoding the one of the sub-blocks in a decoding frame according to the relative position and the reference block corresponding to the one of the sub-blocks,
wherein the reference block is a sub-block corresponding to the one of the sub-blocks and is within a searching range in the decoding frame.

20. The decoding method of claim 19, wherein the step of decoding the one of the sub-blocks according to the relative position and the reference block corresponding to the one of the sub-blocks comprises:
obtaining the relative position;
obtaining a content corresponding to the reference block from the decoding frame according to the relative position; and
copying the content corresponding to the reference block to a position corresponding to the one of the sub-blocks in the decoding frame.

21. The decoding method of claim 20, wherein the searching range comprises at least one other sub-block, wherein before decoding the one of the sub-blocks in the decoding frame, the at least one other sub-block is already decoded.
